(19) United States
(12) Patent Application Publication
(10) Pub. No.: US 2019/0136988 A1
(43) Pub. Date: May 9, 2019

(54) FLOW PATH SWITCHING VALVE AND CLEANING APPARATUS

(71) Applicant: AISIN SEIKI KABUSHIKI KAISHA, Kariya-shi (JP)

(72) Inventors: Taichi MIZUNO, Anjo-shi (JP); Hidetoshi INAYOSHI, Nukata-gun (JP)

(73) Assignee: AISIN SEIKI KABUSHIKI KAISHA, Kariya-shi (JP)

(21) Appl. No.: 16/180,469

(22) Filed: Nov. 5, 2018

(30) Foreign Application Priority Data
Nov. 6, 2017 (JP) 2017-213664
Jun. 5, 2018 (JP) 2018-107782

(51) Int. Cl. F16K 11/085

(52) U.S. Cl. CPC F16K 11/0853

(57) ABSTRACT

A flow path switching valve includes a case, a fluid supply portion, a valve body including a first flow portion and a first opposed surface, a second opposed surface provided at the case, a biasing member, a drive portion, a plurality of second flow portions provided at the second opposed surface, and a plurality of fluid discharge portions communicating with the second flow portions respectively, the fluid supply portion being provided to open to a portion in the inner void, the portion being arranged opposite to the first opposed surface relative to the valve body, the first flow portion including a recess portion provided at the first opposed surface to open towards the second opposed surface, the first flow portion including a communication portion provided at the recess portion as viewed in a direction orthogonal to the first opposed surface to communicate between the recess portion and the inner void.

### CROSS REFERENCE TO RELATED APPLICATIONS

This application is based on and claims priority under 35 U.S.C. § 119 to Japanese Patent Application 2017-213664, filed on Nov. 6, 2017, and Japanese Patent Application 2018-107782, filed on Jun. 5, 2018, the entire contents of which are incorporated herein by reference.

### TECHNICAL FIELD

This disclosure generally relates to a flow path switching valve and a cleaning apparatus.

### BACKGROUND DISCUSSION

A flow path switching valve which changes a flow path to which fluid flows (i.e., a flow destination) by means of a switching member that is rotatable is disclosed, for example, in JP2000-130613A which is hereinafter referred to as Reference 1.

The flow path switching valve disclosed in Reference 1 includes a valve body which is rotatable at an inside of a flow path switching chamber to which fluid flows. The valve body is configured to be pressed against a flat inner wall surface of the flow path switching chamber so that one of plural fluid outlet ports formed at the inner wall surface is selectively in communication with the flow path switching chamber.

The valve body includes a portion which closes each of the fluid outlet ports depending on a rotation phase of the valve body and a cut hole which is connected to a specified or particular fluid outlet port (i.e., a selected fluid outlet port) in the plural fluid outlet ports to bring the fluid at the flow path switching chamber to flow to the aforementioned fluid outlet port. The cut hole is obtained by a void extending through the plate-formed valve body while including the same cross-sectional configuration from an upper surface to a lower surface of the valve body.

The valve body is pressed against the inner wall surface by a disc spring so that a clearance is inhibited from being generated between the valve body and the inner wall surface.

Further, an inclined projection is formed at the inner wall surface in a state where a height of the projection sequentially changes along a rotation direction of the valve body. The valve body moves or climbs upon the projection at a predetermined rotation phase so as to be lifted from the inner wall surface, which results in supply of the fluid to all the fluid outlet ports.

According to the flow path switching valve disclosed in Reference 1, with a relatively simple construction, the flow destination of the fluid is individually selectable. In addition, depending on the rotation phase of the valve body, the supply of the fluid to all the fluid outlet ports is available.

In order to securely change the flow destination of the fluid in the flow path switching valve disclosed in Reference 1, the valve body is required to be appropriately pressed against the inner wall surface to securely separate the adjacent fluid outlet ports from each other.

At this time, based on the construction of the valve body, the cut hole is formed with the same cross-sectional configuration from the upper surface to the lower surface of the plate-formed valve body. Further, an annular penetration groove is formed at the valve body. The projection enters to be positioned within the penetration groove in a case where the valve body is positioned at a predetermined rotation phase so that the valve body is inhibited from moving or climbing upon the projection.

Although the valve body is biased to the fluid outlet ports by the disc spring, a biasing force thereof may be insufficient in a state where the flow path switching valve is employed in an environment with vibrations. In that case, effect of separating the adjacent fluid outlet ports by the disc spring may be deteriorated.

Meanwhile, the fluid at the flow path switching chamber applies a predetermined pressure to the valve body. Nevertheless, because the cut hole and the annular groove are formed at the valve body, the valve body is inhibited from including a construction where the pressure of the fluid is sufficiently utilized. Thus, a switching operation of the valve body to switch between flow paths corresponding to the fluid outlet ports becomes slow, which may cause the fluid to flow to an unexpected flow path.

As mentioned above, according to the known flow path switching valve, effect of changing the path to which the fluid flows by the valve body is not sufficiently exercised.

A need thus exists for a flow path switching valve which is not susceptible to the drawback mentioned above.

### SUMMARY

According to an aspect of this disclosure, a flow path switching valve includes a case, a fluid supply portion provided at the case and supplying a fluid to an inner void of the case, a valve body provided at the inner void to be rotatable and including a first flow portion through which the fluid flowing from the fluid supply portion flows to a specified flow destination, the valve body including a first opposed surface at which the first flow portion opens, a second opposed surface provided at the case to face the first opposed surface, a biasing member disposed over the case and the valve body to press the first opposed surface of the valve body against the second opposed surface, a drive portion driving to rotate the valve body, a plurality of second flow portions provided at the second opposed surface to change a communication state relative to the first flow portion based on a rotation phase of the valve body, and a plurality of fluid discharge portions communicating with the plurality of second flow portions respectively to discharge the fluid to the specified flow destination, the fluid supply portion being provided to open to a portion in the inner void, the portion being arranged opposite to the first opposed surface relative to the valve body, the first flow portion including a recess portion which is provided at a region in a portion of the first opposed surface to open towards the second opposed surface, the recess portion being configured to face each of the plurality of second flow portions, the first flow portion including a communication portion which is provided at a region in a portion of the recess portion as viewed in a direction orthogonal to the first opposed surface to communicate between the recess portion and the inner void.

According to another aspect of this disclosure, a cleaning apparatus includes a fluid tank, a fluid pump pumping and flowing a fluid at the fluid tank, flow paths through which the fluid discharged from the fluid pump flows, the flow paths including a second flow path serving as a rear flow path which brings the fluid to flow to a rear window of a vehicle and a first flow path which brings the fluid to flow to a cleaning object different from the rear window, a first flow path switching valve provided at the first flow path to specify at least one cleaning object as a supply destination of the fluid, a first driver supplying a driving electric power to the first flow path switching valve, a second flow path switching valve provided at the second flow path to change the supply destination of the fluid to a rear view support apparatus, a second driver supplying a driving electric power to the second flow path switching valve, and a control unit sending a driving signal to each of the first driver, the second driver and the fluid pump, at least one of the first flow path switching valve and the second flow path switching valve being constituted by a flow path switching valve including a case, a fluid supply portion provided at the case and supplying a fluid to an inner void of the case, a valve body provided at the inner void to be rotatable and including a first flow portion through which the fluid flowing from the fluid supply portion flows to a specified flow destination, the valve body including a first opposed surface at which the first flow portion opens, a second opposed surface provided at the case to face the first opposed surface, a biasing member disposed over the case and the valve body to press the first opposed surface of the valve body against the second opposed surface, a drive portion driving to rotate the valve body, a plurality of second flow portions provided at the second opposed surface to change a communication state relative to the first flow portion based on a rotation phase of the valve body, and a plurality of fluid discharge portions communicating with the plurality of second flow portions respectively to discharge the fluid to the specified flow destination, the fluid supply portion being provided to open to a portion in the inner void, the portion being arranged opposite to the first opposed surface relative to the valve body, the first flow portion including a recess portion which is provided at a region in a portion of the first opposed surface to open towards the second opposed surface, the recess portion being configured to face each of the plurality of second flow portions, the first flow portion including a communication portion which is provided at a region in a portion of the recess portion as viewed in a direction orthogonal to the first opposed surface to communicate between the recess portion and the inner void.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is an exploded perspective view illustrating a construction of a flow path switching valve according to a first embodiment disclosed here;

FIG. 2 is a sectional side view illustrating the construction of the flow path switching valve according to the first embodiment;

FIG. 3 is a perspective view illustrating an external appearance of the flow path switching valve according to the first embodiment;

FIG. 4 is an explanatory view illustrating arrangements of a first flow portion and second flow portions according to the first embodiment;

FIG. 5 is a sectional side view illustrating a construction of a flow path switching valve according to a second embodiment disclosed here;

FIG. 6 is a sectional side view illustrating a construction of a flow path switching valve according to a third embodiment disclosed here;

FIG. 7 is an explanatory view illustrating a seal member according to the third embodiment;

FIG. 8 is a sectional side view illustrating a construction of a flow path switching valve according to a fourth embodiment disclosed here;

FIG. 9 is a sectional side view illustrating a construction of a flow path switching valve according to a fifth embodiment disclosed here;

FIG. 10 is a sectional side view illustrating a construction of a flow path switching valve according to a sixth embodiment disclosed here;

FIG. 11 is a sectional side view illustrating a construction of a flow path switching valve according to a seventh embodiment disclosed here;

FIG. 12 is an explanatory view illustrating a construction of a first example of a cleaning apparatus according to the first embodiment;

FIG. 13 is an explanatory view illustrating a construction of a second example of a cleaning apparatus;

FIG. 14 is an explanatory view illustrating a construction of a third example of a cleaning apparatus;

FIG. 15 is an explanatory view illustrating a construction of a fourth example of a cleaning apparatus; and

FIG. 16 is an explanatory view illustrating a construction of a fifth example of a cleaning apparatus.

### DETAILED DESCRIPTION

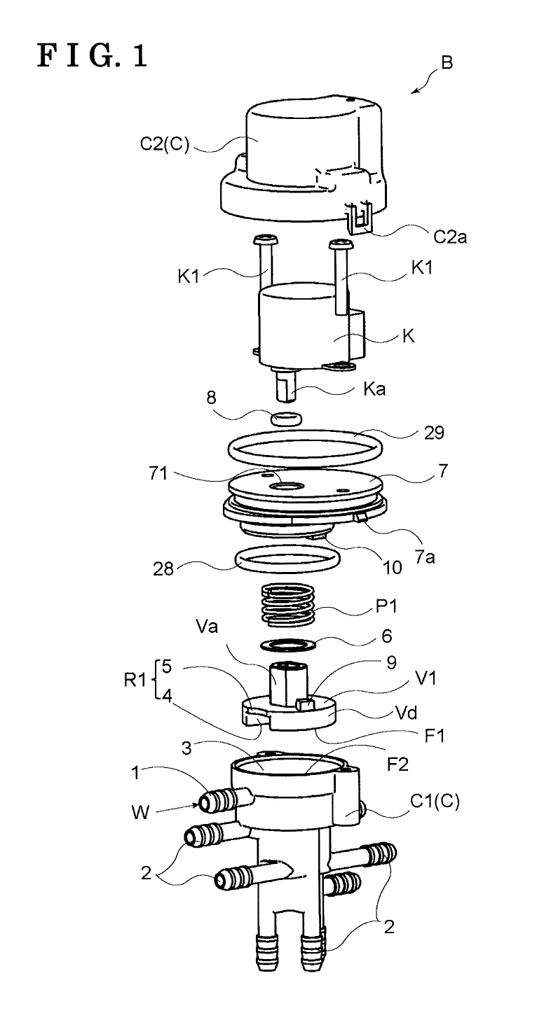

A first embodiment of a flow path switching valve B is explained with reference to FIGS. 1 to 4.

The flow path switching valve B is applicable to a valve which appropriately changes a flow path to which water for cleaning (cleaning water) serving as fluid W flows, i.e., changes a flow destination of the fluid W, at a cleaning apparatus cleaning a headlight or an onboard camera, for example, of a vehicle 12 (see FIG. 12). The flow path switching valve B includes a single fluid supply portion 1 supplying the fluid W to an inside of a case C which substantially entirely constitutes the flow path switching valve B and plural fluid discharge portions 2 discharging the fluid W to respective flow destinations (flow paths, flow portions). The flow destination of the fluid W is changed (i.e., selected) at the inside of the case C. Each of the fluid supply portion 1 and the fluid discharge portions 2 is configured in a nozzle form. A valve body V1 which is rotatable is provided at an inner void 3 of the case C so as to bring the fluid W to flow from the fluid supply portion 1 to any one of the plural fluid discharge portions 2.

As illustrated in FIG. 1, the case C includes a first case C1 at which the fluid supply portion 1 and the plural fluid discharge portions 2 are formed and a second case C2 functioning as a cover member of the first case C1. According to the flow path switching valve B of the present embodiment, the valve body V1 is first inserted to the first case C1 and then a biasing member P1 is inserted to a boss portion Va of the valve body V1 via a washer 6. From an upper side of the aforementioned assembly, a wall member 7 is fitted to the first case C1 while sandwiching a first packing 28 made from rubber material for tight sealing relative to the first case C1. A stepping motor serving as a drive portion K is placed onto an upper surface of the wall member 7. A drive shaft Ka of the stepping motor is inserted to be positioned within a shaft bore 71 of the wall member 7. A rubber ring 8 for sealing is disposed between the shaft bore 71 and the drive shaft Ka. The drive portion K, the wall member 7 and the first case C1 are integrated via fixing bolts K1.

A second packing 29 for sealing is arranged around the wall member 7. The drive portion K is covered by the second case C2. At this time, an engagement recess portion C2a provided at the second case C2 engages with an engagement protruding portion 7a provided at an edge portion of the wall member 7.

The inner void 3 is provided at the inside of the first case C1 so as to store the fluid W supplied via the fluid supply portion 1. The inner void 3 is cylindrically formed, for example. The valve body V1 including a disc-formed portion, for example, is arranged at the inner void 3. The valve body V1 is driven to rotate by the drive portion K arranged adjacent to the inner void 3. The drive portion K is driven and controlled by a control unit E (see FIG. 12).

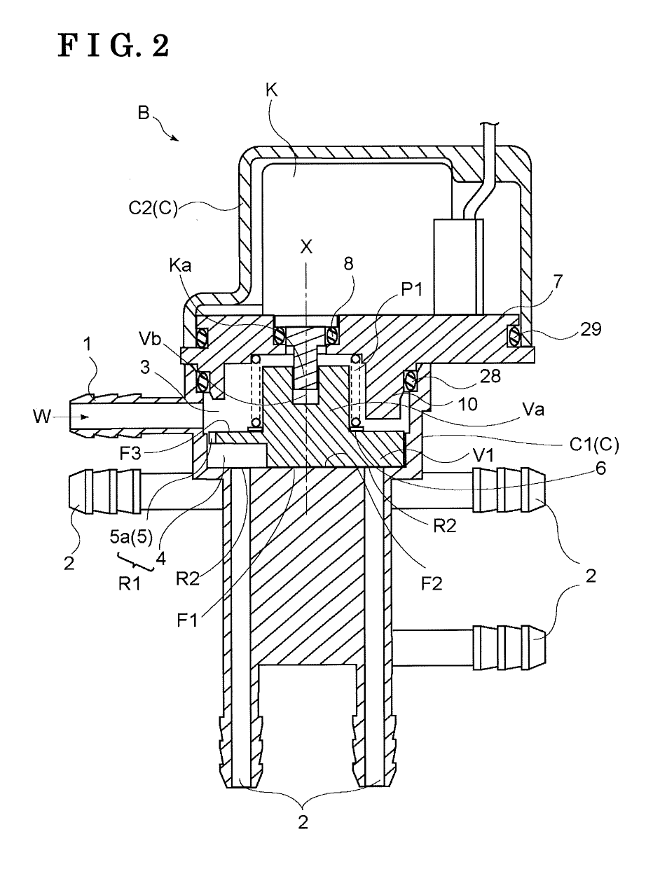

The valve body V1 is pressed by the biasing member P1 against one wall portion which partially constituting the inner void 3. At this time, two surfaces making contact with each other is constituted by a first opposed surface F1 formed at the valve body V1 and a second opposed surface F2 formed at the first case C1. As illustrated in FIG. 2, the disc-formed portion of the valve body V1 includes the first opposed surface F1 and a pressurized surface F3 at an opposite side of the first opposed surface F1, the pressurized surface F3 being pressed by the fluid W at the inner void 3.

A first flow portion R1 is formed at the valve body V1 for bringing the fluid W at the inner void 3 to flow to the first opposed surface F1. As illustrated in FIGS. 1 and 2, for example, the first flow portion R1 includes a recess portion 4 formed at a region in a portion of the first opposed surface F1 to open towards the second opposed surface F2, and a communication portion 5 formed at a region in a portion of the recess portion 4 as viewed in a direction orthogonal to the first opposed surface F1 to communicate between the recess portion 4 and the inner void 3.

As illustrated in FIGS. 1 and 4, the recess portion 4 opens to the first opposed surface F1 and a lateral surface Vd of the valve body V1. Further, a cut portion 5a in an arc form is provided at an edge portion of the valve body V1 so as to serve as the communication portion 5 and to communicate between the recess portion 4 and the pressurized surface F3.

The valve body V1 rotates by means of the stepping motor, for example, provided at the drive portion K. The recess portion 4 moves in an arc along the second opposed surface F2. Plural second flow portions R2 are therefore dispersedly arranged along a moving locus of the recess portion 4. Opening areas of the respective second flow portions R2 are differentiated from one another depending on each flow destination of the fluid W. For example, one of the second flow portions R2 supplying the fluid W to the front window of the vehicle 12 which requires a large volume of flowing fluid includes a large opening area. On the other hand, another one of the second flow portions R2 supplying the fluid W to the rear camera which requires less volume of flowing fluid includes a small opening area. The second flow portions R2 are not necessarily arranged on the same circumference, because of the positions of the fluid discharge portions 2 relative to the first case C1. Thus, the recess portion 4 includes a greater opening area than the opening area of each of the second flow portions R2 so as to face each of the all second flow portions R2 based on the rotation of the valve body V1.

In a case where the first flow portion R1 is formed by a cutout including the same cross-sectional configuration from the pressurized surface F3 to the first opposed surface F1, for example, an area of the pressurized surface F3 is small. In that case, the area (opening area) of the first flow portion R1 is greater than the opening area of each of the second flow portions R2. Nevertheless, because the flow volume of the fluid W flowing through the first flow portion R1 is defined on a basis of the opening area of each of the second flow portions R2, the opening area of the first flow portion R1 is not necessarily enlarged.

Therefore, according to the present embodiment, as illustrated in FIGS. 1 and 4, the communication portion 5 is formed by the cut portion 5a obtained by cutting a portion of the pressurized surface F3 to an arc form so that the cut portion 5a overlaps a region in a portion of the recess portion 4 as viewed in a direction orthogonal to the first opposed surface F1.

Because of the aforementioned cut portion 5a, not only an appropriate volume of the fluid W is supplied to each of the second flow portions R2 but also an applied pressure to the pressurized surface F3 by the fluid W stored at the inner void 3 may be maximized while the area of the pressurized surface F3 is inhibited from being excessively reduced. As a result, even in a case where the flow path switching valve B is employed in an environment with vibrations such as at the vehicle 12, for example, the first opposed surface F1 and the second opposed surface F2 are tightly in contact with each other, which may increase reliability of switching function of the flow path switching valve B for changing a supply destination (i.e., flow destination) of the fluid W.

An effect of strongly tightly contacting the first opposed surface F1 and the second opposed surface F2 each other is influenced by the position where the fluid supply portion 1 is provided. As illustrated in FIG. 2, the fluid supply portion 1 is connected laterally to the first case C1 to supply the fluid W to the inner void 3. Because of such construction of the fluid supply portion 1, the height of the flow path switching valve B is lowered to reduce the size thereof. At this time, because the fluid W flows at substantially right angle relative to the moving direction of the valve body V1, a force for moving the valve body V1 is only the pressure at the inner void 3.

Therefore, according to the present embodiment, an opening position of the fluid supply portion 1 relative to the first case C1 is configured to a position facing the pressurized surface F3 of the valve body V1 in the inner void 3. That is, the fluid supply portion 1 is provided to open to a portion in the inner void 3, the portion being arranged opposite to the first opposed surface F1 relative to the valve body V1. The pressure of the fluid W flowing to the inner void 3 is thus immediately applied to the pressurized surface F3 so that the first opposed surface F1 of the valve body V1 is pressed against the second opposed surface F2. One of the second flow portions R2 (i.e., specified second flow portion R2) is selected accordingly.

The biasing member P1 which presses the valve body V1 against the second opposed surface F2 is a coil spring disposed over the first case C1 and the valve body V1 as illustrated in FIG. 1, for example. The washer 6 in an annular form is arranged between the coil spring and the pressurized surface F3 so that the valve body V1 is smoothly rotatable.

The drive shaft Ka includes a non-circular cross-section which is partially chamfered, for example. The valve body V1 includes the boss portion Va at which a drive bore Vb is formed, the drive bore Vb with which the drive shaft Ka is engageable. Because the valve body V1 necessarily comes closer to and separates from the second opposed surface F2 over a certain amount of distance, the drive shaft Ka and the drive bore Vb are relatively movable in an axial direction of the valve body V1 (the drive portion K).

The valve body V1 may be set to a predetermined rotation phase by the drive portion K. It is necessary to confirm a reference position of the stepping motor at a predetermined position of the valve body V1. Thus, as illustrated in FIG. 1, a reference projection 9 is provided at a portion of the pressurized surface F3 of the valve body V1. In addition, a stopper 10 is provided at a surface of the wall member 7 facing the pressurized surface F3. The reference projection 9 makes contact with the stopper 10 in a case where the valve body V1 rotates to respective rotation end portions in a forward direction and a reverse direction around a rotation axis X of the drive portion K (the valve body V1). Accordingly, the present position of the valve body V1 may be reset in a case where the valve body V1 is driven to each of the rotation end portions or is forced to rotate to each of the rotation end portions at predetermined timing.

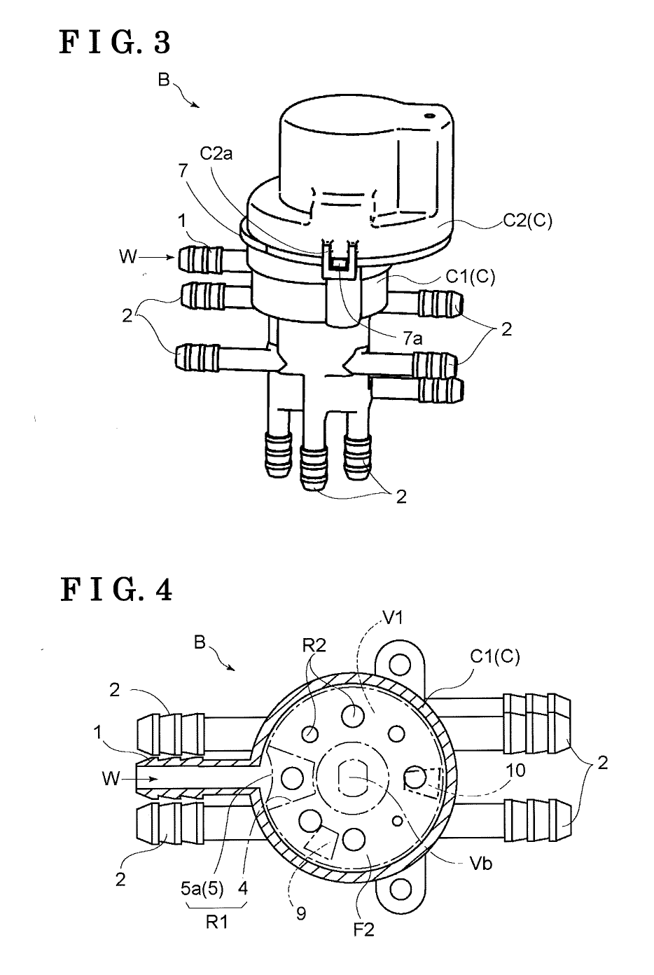

As illustrated in FIGS. 3 and 4, eight of the second flow portions R2 are provided at the first case C1 in the present embodiment. The fluid discharge portions 2 extend from the respective second flow portions R2. As illustrated in FIG. 4, the opening area of each of the second flow portions R2 is appropriately specified depending on a required flow volume at each flow destination to which the fluid W is discharged. For example, the flow destination of one of the second flow portions R2 with the large opening area may be designated or specified to the front window or the rear window of the vehicle 12, for example. On the other hand, the flow destination of another one of the second flow portions R2 with the small opening area may be designated or specified to the left or right side camera or the rear camera of the vehicle 12, for example. Accordingly, even in a case where a single fluid pump 11 is employed, for example, the fluid W with a predetermined flow speed may be supplied to each flow destination.

According to the flow path switching valve B with the aforementioned construction, the area of the pressurized surface F3 is configured to be enlarged or maximized. Thus, the valve body V1 may be pressed against the second flow portions R2 by the maximum pressure of the fluid W. Upon changing or switching of the flow path, leakage of the fluid W especially to the second flow portions R2 which do not match the position of the recess portion 4 is securely inhibited, which improves reliability of flow path switching function.

The flow path switching valve B in the present embodiment is applicable to a cleaning apparatus (i.e., a first example of a cleaning apparatus) of the vehicle 12 as illustrated in FIG. 12, for example. The cleaning apparatus illustrated in FIG. 12 selectively supplies the cleaning water (i.e., the fluid W) at a fluid tank 13 which is mounted at the vehicle 12 by the flow path switching valve B not only to a front window washer 30 for a front window 40 and a rear window washer 33 for a rear window 41 but also to a front camera washer 31 for a front camera 42 utilized during an automatic driving or for a digital mirror, a rear camera washer 34 for a rear camera 43, and left and right camera washers 32 for left and right cameras 44, for example.

The flow path switching valve B is operated on a basis of a manual operation of a driver or a stain detection signal 14 resulting from analysis of an image captured by each camera, for example. When the stain detection signal 14 is input to the control unit E, the control unit E operates the flow path switching valve B so that a flow path 15 is changed to be connected to a portion where cleaning is necessary. After the connection of the flow path 15 is changed, the control unit E operates the fluid pump 11 which pumps the cleaning water to jet out the cleaning water for cleaning only to a portion where cleaning is necessary. Accordingly, a discharge volume of the fluid pump 11 may be small, which results in downsizing of the fluid tank 13. Saving of cleaning water is available and a portion of the vehicle 12 which does not require cleaning is inhibited from being applied with the cleaning water.

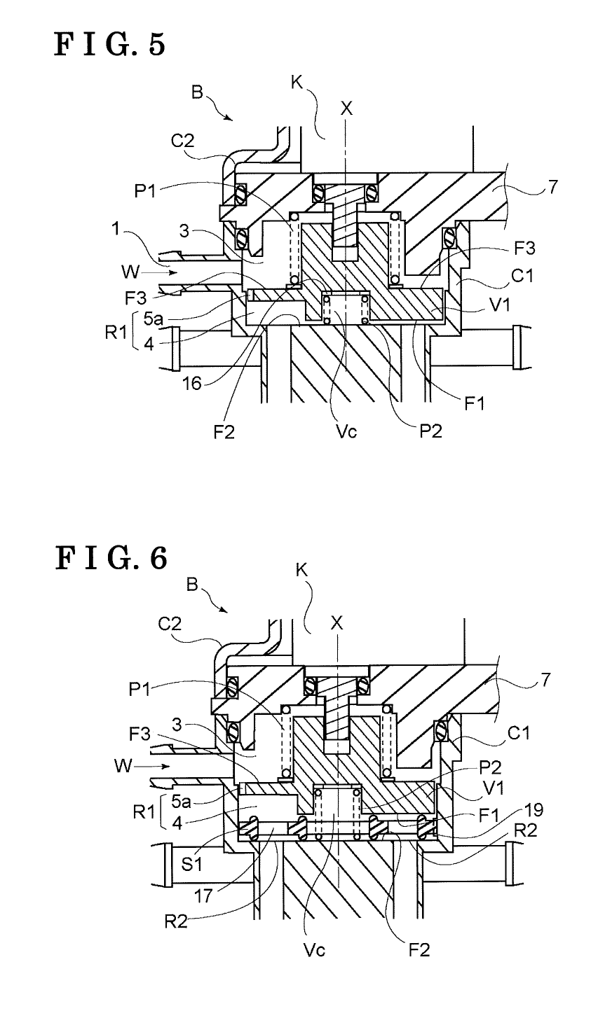

A second embodiment of the flow path switching valve B is explained with reference to FIG. 5. As illustrated in FIG. 5, a second biasing member P2 may be disposed between the first case C1 and the valve body V1. A mounting bore Vc where the second biasing member P2 is mounted with the center of the rotation axis X is formed at the first opposed surface F1 of the valve body V1. A coil spring serving as the second biasing member P2, for example, is inserted to be positioned within the mounting bore Vc to apply a biasing force in a direction where the valve body V1 and the second opposed surface F2 are separated from each other. A second washer 16 may be desirably provided between the second biasing member P2 and a bottom portion of the mounting bore Vc for reducing a friction therebetween.

As the second biasing member P2, a disc spring may be employed instead of the coil spring. Alternatively, magnets with the same poles may be provided at the first opposed surface F1 and the second opposed surface F2 so as to utilize a magnetic reaction force. Any construction for separating the valve body V1 from the second opposed surface F2 is available.

The biasing force of the second biasing member P2 is specified greater than the biasing force of the biasing member P1. Accordingly, the first opposed surface F1 is inhibited from making contact with an object such as the second opposed surface F2, for example, in a state where the fluid W is not supplied from the fluid supply portion 1 to the inner void 3 of the first case C1.

According to the aforementioned construction, the drive portion K is operated before the fluid W is supplied to the inner void 3 so as to promptly change the rotation phase of the valve body V1 with a small power. Because the fluid W is supplied to the inner void 3 after the rotation phase is changed, the pressure of the fluid W is applied to the pressurized surface F3 so that the valve body V1 is pressed against the second opposed surface F2 in cooperation with the biasing force of the biasing member P1. The phase change is promptly performed while the construction of the drive portion K is simplified and downsized. The downsizing and light-weight of the flow path switching valve B are obtainable while durability of the valve body V1 and the second opposed surface F2 are enhanced.

Further, because the valve body V1 is separated from the second opposed surface F2, the fluid W which has been already supplied to the second flow portion R2 may be pulled back in a case where the fluid pump 11 is reversely rotated to return the fluid W at the inner void 3 to the fluid tank 13. Thus, leaking of the fluid W to the flow destination after the supply of the fluid W is stopped is inhibited or freezing of the fluid W within a supply pipe (flow pipe) ahead of the second flow portion R2, for example, is avoidable.

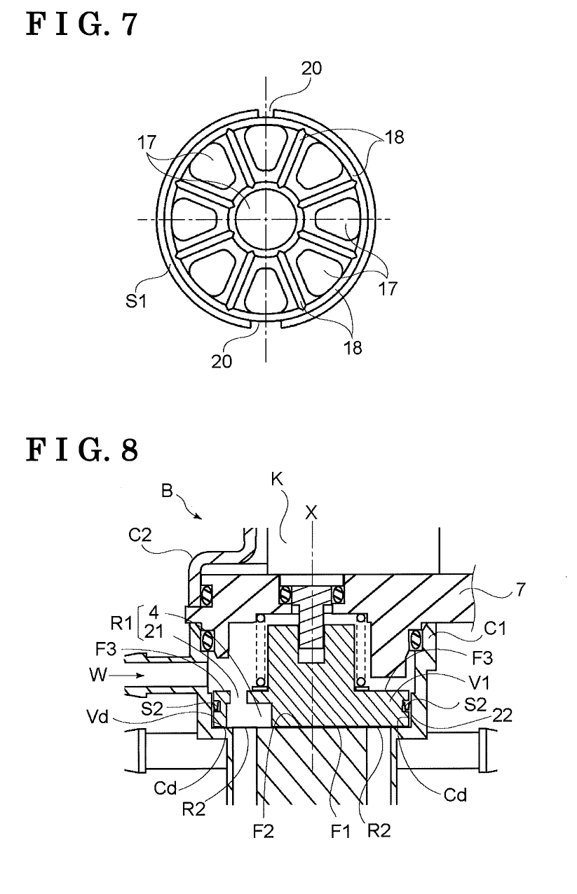

A third embodiment of the flow path switching valve B is explained with reference to FIGS. 6 and 7. As illustrated in FIGS. 6 and 7, a seal member S1 may be arranged between the first opposed surface F1 and the second opposed surface F2. The seal member S1 is constituted by any kind of elastic rubber material or resin material, for example. As illustrated in FIG. 7, bore portions 17 are formed at the seal member S1 so as to be positioned corresponding to the plural second flow portions R2 and the second biasing member P2 at a center. In addition, each partition portion 18 in a bulged form is provided between the adjacent bore portions 17. Further, positioning portions 20 each of which is in a cutting form are provided at an outer peripheral portion of the seal member S1. Each of the positioning portions 20 engages with an engagement projection 19 provided at the first case C1 to inhibit a rotation of the seal member S1 in conjunction with the rotation of the valve body V1.

The seal member S1 is sandwiched between the first opposed surface F1 and the second opposed surface F2 to be compressed and deformed by a predetermined amount when the valve body V1 is pressed against the second opposed surface F2. Thus, the adjacent second flow portions R2 may by securely partitioned and separated from each other. As a result, reliability of the switching function of the flow path switching valve B for changing the flow destination of the fluid W is enhanced.

In addition, with the second biasing member P2, the valve body V1 is normally separated from the seal member S1 so that a rotation resistance of the valve body V1 is reduced. The phase change of the valve body V1 is therefore promptly performed to thereby reduce the size of the drive portion K.

A fourth embodiment of the flow path switching valve B is explained with reference to FIG. 8. As illustrated in FIG. 8, a second seal member S2 may be arranged between the valve body V1 and the first case C1. For example, an inner wall Cd in a cylindrical form is provided at the first case C1 in a state where the lateral surface Vd in a cylindrical form with the center of the rotation axis X of the drive portion K is formed at the outer peripheral portion of the valve body V1. The second seal member S2 is disposed between the lateral surface Vd and the inner wall Cd which are concentrically provided with each other.

A penetration path 21 serving as the first flow portion R1 such as illustrated in FIG. 8 is formed at the valve body V1 for bringing the fluid W to flow to the first opposed surface F1 from the pressurized surface F3. As viewed in the direction along the rotation axis X, an opening area of the penetration path 21 is specified smaller than an area of the recess portion 4 provided at the first opposed surface F1.

A common rubber-made O-ring is employed as the second seal member S2, for example. An annular groove portion 22 to which the second seal member S2 is fitted may be formed at least at one of the valve body V1 and the first case C1. In addition, as illustrated in FIG. 8, an annular member including a V-shaped cross-section may be utilized as the second seal member S2. In this case, the annular member is configured to be deformed in a manner that the V-shaped portion expands to thereby securely inhibit or block the fluid W from flowing out to the first opposed surface F1 from the pressurized surface F3. As a result, the valve body V1 may be promptly pressed towards the second opposed surface F2.

As mentioned above, because the second seal member S2 separates or partitions the pressurized surface F3 and the first opposed surface F1 of the valve body V1, the pressure of the fluid W is securely applied to the pressurized surface F3 when the fluid W flows into the inner void 3. A force pressing the valve body V1 to the second opposed surface F2 may therefore increase. The fluid W is inhibited from flowing to the second flow portion R2 which does not serve as the supply destination, thereby securely obtaining the switching function of the flow path switching valve B for chancing the flow destination.

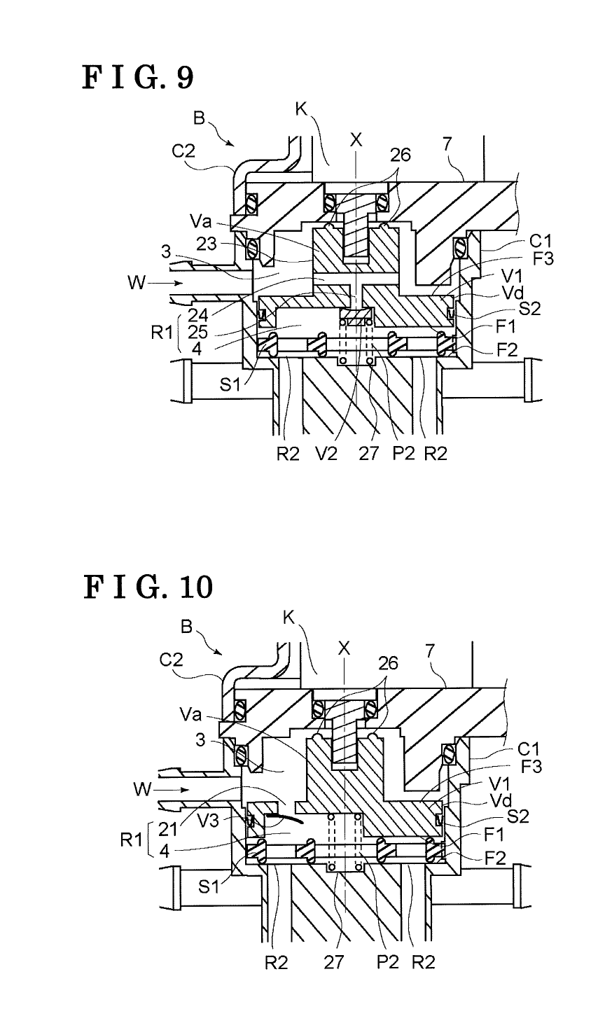

A fifth embodiment of the flow path switching valve B is explained with reference to FIG. 9. As illustrated in FIG. 9, a second valve body V2 which opens when the pressure of the fluid W at the inner void 3 reaches or exceeds a predetermined pressure may be provided at the first flow portion R1 of the valve body V1. Specifically, the second biasing member P2 is provided with the center of the rotation axis X of the valve body V1, for example, and the first flow portion R1 is provided at a center of the valve body V1. The first flow portion R1 includes, for example, a lateral bore 24 opening at the lateral surface 23 of the boss portion Va of the valve body V1 and a longitudinal bore 25 communicating with the lateral bore 24 and formed along the rotation axis X. The second valve body V2 normally closes the longitudinal bore 25 by means of the second biasing member P2.

The second biasing member P2 presses the valve body V1 in a direction opposite to the second opposed surface F2 via the second valve body V2 so that the valve body V1 makes contact with the wall member 7. In the present embodiment, except the second biasing member P2, a biasing member such as the biasing member P1 is not particularly provided. Thus, contact protrusions 26 configured to make contact with the wall member 7 are provided at an end portion of the boss portion Va of the valve body V1. Each of the contact protrusions 26 may be desirably formed as an annular bulged portion, for example, so as to decrease a contact area with the wall member 7 to thereby decrease the rotation resistance of the valve body V1.

In addition, the seal member S1 is arranged between the first opposed surface F1 and the second opposed surface F2 and the second seal member S2 is provided at the lateral surface Vd of the valve body V1.

When the fluid W is supplied to the inner void 3, the pressurized surface F3 of the valve body V1 is pressed by the fluid W so that the valve body V1 moves towards the second opposed surface F2. At this time, the longitudinal bore 25 of the valve body V1 is kept closed. When the valve body V1 makes contact with the seal member S1 and the pressure of the fluid W further increases, the second valve body V2 is opened.

In order to inhibit the position of the second valve body V2 from being unstable when the second valve body V2 is opened, a spring receiving recess portion 27 may be desirably formed at a portion in the second opposed surface F2 with which the second biasing member P2 makes contact.

In addition, the portion of the second valve body V2 which is configured to make contact with the valve body V1 may be formed in a recess (see FIG. 9) so that a circumference of the longitudinal bore 25 is securely surrounded by the aforementioned recess portion which also makes linear contact with the valve body V1. Alternatively, the aforementioned portion of the second valve body V2 may be formed in a spindle form of which end is fitted in the longitudinal bore 25. Further alternatively, a rubber member, for example, may be provided at least at one of the valve body V1 and the second valve body V2 so as to serve as a valve seat.

Because the second valve body V2 is positioned at the center of the valve body V1, the second biasing member P2 includes both functions to separate the valve body V1 from the seal member S1 in a state where the position or posture of the valve body V1 is stabilized and to open and close the second valve body V2, which results in a reasonable construction.

A sixth embodiment of the flow path switching valve B is explained with reference to FIG. 10. As illustrated in FIG. 10, as another example of the aforementioned second valve body V2, a valve body may be provided at a portion of the recess portion 4 instead of the center of the valve body V1. In this case, the penetration path 21 functioning as the first flow portion R1 is formed to penetrate through from the pressurized surface F3 to the recess portion 4 and a third valve body V3 in a thin plate form is provided at the recess portion 4, for example.

The third valve body V3 is formed of metal including elasticity or resin material, for example. The third valve body V3 is configured to normally close the first flow portion R1 and to open the first flow portion R1 when the pressure of the fluid W at the inner void 3 increases. The pressure at the inner void 3 may therefore immediately increase at the time of supply of the fluid W. As a result, the prompt operation of the valve body V1 is obtainable and the switching function switching between the second flow portions R2 is stabilized.

The second seal member S2 is provided at the lateral surface Vd of the valve body V1 so that the pressure at the inner void 3 immediately increases upon supply of the fluid W and the second flow portions R2 are securely partitioned and separated from one another.

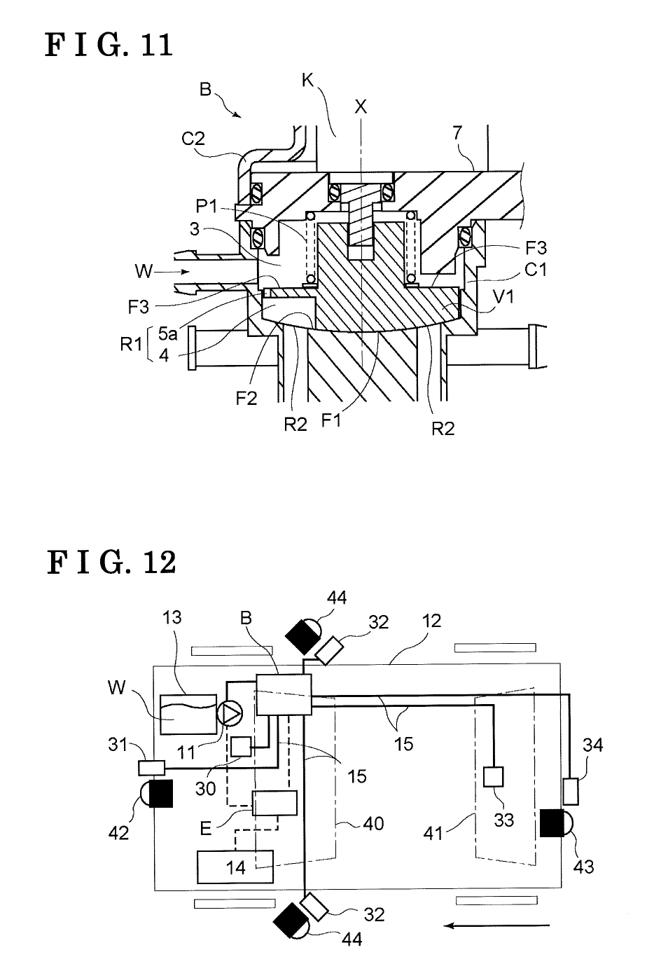

A seventh embodiment of the flow path switching valve B is explained with reference to FIG. 11. As illustrated in FIG. 11, each of the first opposed surface F1 and the second opposed surface F2 may be formed with a spherical surface. In the seventh embodiment, the biasing member P1 is provided but the second biasing member P2 or the seal member S1 is not provided.

With the aforementioned construction, even when the valve body V1 is inclined upon driving of the drive portion K, a clearance between the first opposed surface F1 and the second opposed surface F2 is inhibited from being excessively expanded. Thus, improved sealing performance may be maintained at each of the second flow portions R2.

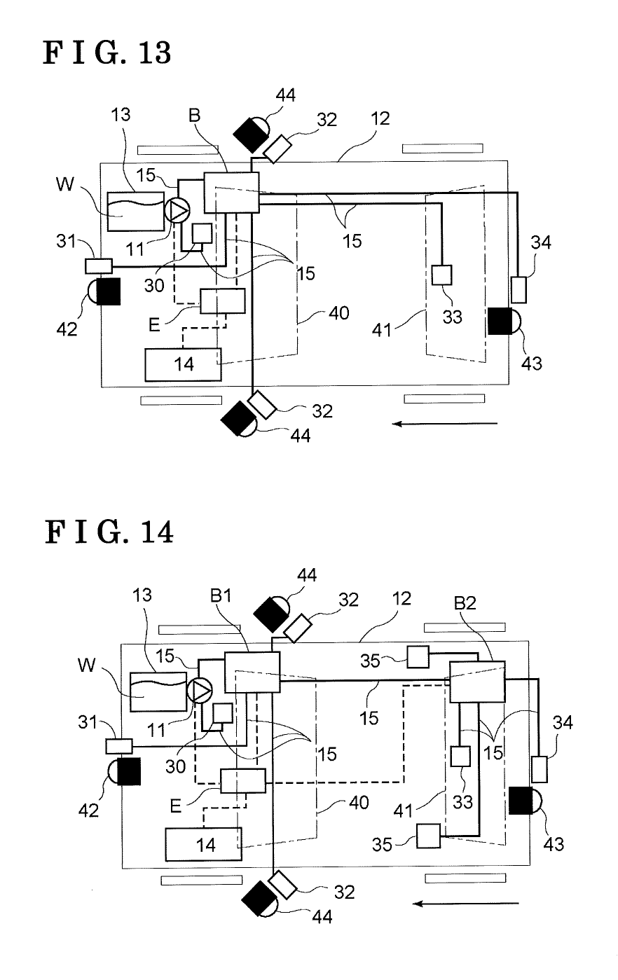

FIG. 13 illustrates a second example of the cleaning apparatus where the flow path switching valve B of each of the aforementioned embodiments is mountable. According to the second example of the cleaning apparatus, the fluid pump 11 operates selectively in a forward direction and in a reverse direction to thereby individually supply the cleaning water (the fluid W) to one of and the other of the flow paths 15 extending from the fluid pump 11. The flow path switching valve B is connected to one of the flow paths 15 and the front window washer 30 is connected to the other of the flow paths 15. That is, the front window washer 30 of which usage frequency is high is directly connected to the fluid pump 11 so that a switching time of the flow path switching valve B is eliminated. Pressure loss at a piping, for example, provided at the flow path switching valve B is eliminated to achieve prompt operation. The other flow destinations than the front window washer 30 are switched therebetween by the flow path switching valve B.

In addition to the front camera washer 31, the left and right camera washers 32, the rear window washer 33 and the rear camera washer 34 are connected to a downstream of the flow path switching valve B.

FIG. 14 illustrates a third example of the cleaning apparatus where the flow path switching valve B of each of the aforementioned embodiments is mountable. According to the third example of the cleaning apparatus, a first flow path switching valve B1 serving as the flow path switching valve and a second flow path switching valve B2 serving as the flow path switching valve are provided at a front portion and a rear portion of the vehicle 12 respectively. The first flow path switching valve B1 provided at the front portion of the vehicle 12 is connected to one of the flow paths 15 of the fluid pump 11 which is operable in the forward direction and the reverse direction in the same manner as the second example of the cleaning apparatus. In addition to the front camera washer 31, the left and right camera washers 32 are connected to a downstream of the first flow path switching valve B1. In addition, the rear window washer 33, the rear camera washer 34, and a various sensor washer 35 are connected to a downstream of the second flow path switching valve B2.

Whether the first flow path switching valve B1 is utilized or the second flow path switching valve B2 is utilized is determined by the control unit E based on a manual operation signal sent from a driver or the stain detection signal 14 sent from any kind of stain sensors, for example. With the aforementioned construction, the single flow path 15 is provided between the first flow path switching valve B1 and the second flow path switching valve B2 to thereby simplify the construction. In addition, in a case where the flow volume of the flow path 15 provided between the first flow path switching valve B1 and the second flow path switching valve B2 is sufficient, decrease in fluid pressure at any of the flow destinations is inhibited, which maintains high cleaning effect. Further, the first flow path switching valve B1 and the second flow path switching valve B2 are provided at the front portion and the rear portion of the vehicle 12 respectively, so that a sensor such as a light detection and ranging (LIDAR) may be easily added to the vehicle 12.

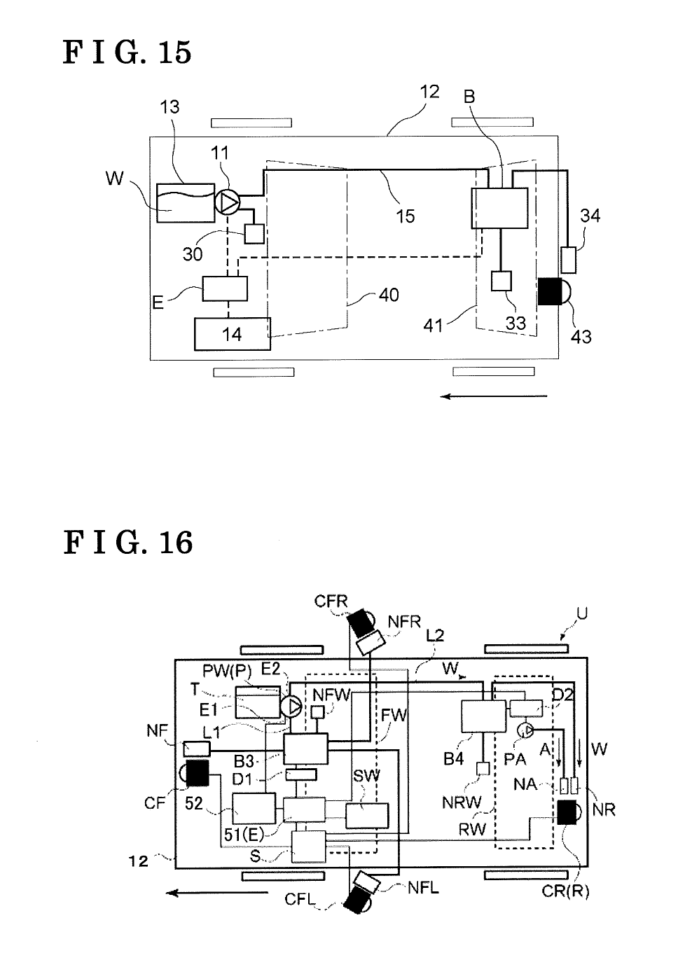

FIG. 15 illustrates a fourth example of the cleaning apparatus where the flow path switching valve B of each of the aforementioned embodiments is mountable. According to the fourth example of the cleaning apparatus, the front window washer 30 and the flow path 15 connected to the rear portion of the vehicle body are switched therebetween on a basis of the forward and reverse operation of the fluid pump 11. The flow path switching valve B is provided at the flow path 15 that is arranged at the rear portion of the vehicle body. Further, the flow path 15 from the flow path switching valve B is switched to be connected between the rear window washer 33 and the rear camera washer 34. In the vehicle 12 serving as a commonly used vehicle, cleaning nozzles are normally provided only at the front window 40 and the rear window 41. In the present construction, it is not necessary to provide the flow path switching valve at the front portion of the vehicle 12. Thus, the cleaning apparatus for the rear camera 43 may be added with a simple construction.

As the fluid pump 11 supplying the fluid W to the rear camera 43, a pump for a headlight may be employed, for example. In a case where the fluid pump 11 which supplies the fluid W to the front window 40 is also used for the rear camera 43, for example, as in the aforementioned embodiments, the flow volume of the fluid pump 11 is specified to be relatively large because the fluid W is discharged to the front window 40 including a large area. The aforementioned flow volume is desirable for the rear window 41 but may be excessive for the rear camera 43.

Thus, in a case where a pump with a small flow volume for a headlight is mounted at the vehicle 12, for example, the pump with the small flow volume is desirably utilized so that the fluid W is inhibited from being discharged to an unnecessary portion in the vehicle 12.

FIG. 16 illustrates a fifth example of the cleaning apparatus serving as a cleaning apparatus U where the flow path switching valve B of each of the aforementioned embodiments is mountable. In the cleaning apparatus U, a first flow path switching valve B3 serving as the flow path switching valve and a second flow path switching valve B4 serving as the flow path switching valve are provided at the front portion and the rear portion of the vehicle 12 respectively. Each of the first flow path switching valve B3 and the second flow path switching valve B4 corresponds to the flow path switching valve B according to the aforementioned embodiments but is not limited thereto. Each of the first flow path switching valve B3 and the second flow path switching valve B4 may be a valve that selects, for switching, a specified flow path among plural flow paths supplying the fluid. The cleaning apparatus U is mounted at the vehicle 12, for example, and is provided in particular to clean a rear view support apparatus R such as a camera and a collision sensor, for example, provided at the rear portion of the vehicle 12.

The cleaning apparatus U includes a fluid tank T which stores the fluid W and a fluid pump P pumping and circulating the fluid W to the rear view support apparatus R. Water for cleaning (cleaning water), for example, is employed as the fluid W. The fluid pump P is referred to as a water pump PW according to the present embodiment.

As illustrated in FIG. 16, the water pump PW includes a first port E1 and a second port E2, the first port E1 and the second port E2 serving as two discharge ports. The first port E1 is connected to a front flow path L1 which supplies the fluid W to a cleaning nozzle NFW for a front window FW, for example. The first flow path switching valve B3 is provided at the front flow path L1. Based on a switching operation of the first flow path switching valve B3, the fluid W is selectively supplied to a front camera CF, a right camera CFR, and a left camera CFL besides the front window FW. The second port E2 is connected to a rear flow path L2 which supplies the fluid W to a rear window RW and a rear camera CR for rear view monitoring. Whether the fluid W is discharged to the first port E1 or the second port E2 is determinable by a rotation direction of the water pump PW.

The supply destination of the fluid W is decided on a basis of the operation of the fluid pump P in the forward direction and the reverse direction so as to inhibit decrease in supply pressure of the fluid W especially to the rear flow path L2 at which the rear window RW and the rear camera CR are provided, for example. That is, if the rear flow path L2 serves as one of branch destinations provided at a downstream of the first flow path switching valve B3 and further that the fluid W is supplied to the rear window RW and the rear camera CR via the second flow path switching valve B4, the pressure of the fluid W discharged from the water pump PW may be likely to decrease. Nevertheless, according to the construction of the present embodiment, the fluid W holding the original discharge pressure of the water pump PW may be supplied to the second flow path switching valve B4. Therefore, the pressure of the fluid at the rear camera CR, for example, which is positioned away from the water pump PW is inhibited from decreasing. Cleaning effect may be maintained to be high accordingly.

The first flow path switching valve B3 supplies the fluid W discharged from the water pump PW to the front window FW, the front camera CF, the left camera CFL and the right camera CFR, for example. The water pump PW is driven by an operation of a cleaning switch SW which is operated by an operator for the purposes of cleaning each portion. Once the cleaning switch SW is operated, a command signal is output to a first driver D1 via a cleaning ECU 51 and a driving signal is output to the first flow path switching valve B3. As a result, the first flow path switching valve B3 is operated so that one supply destination of the fluid W is selected and determined. Afterwards, the water pump PW is driven by the cleaning ECU 51 so that the fluid W is discharged to a cleaning object. The fluid W discharged to the front camera CF, the left camera CFL and the right camera CFR is substantially completely removed by wind generated during driving of the vehicle 12.

The second flow path switching valve B4 is provided at a portion of the rear flow path L2. In the present embodiment, the second flow path switching valve B4 switches supply of the fluid W between the rear window RW and the rear camera CR. The second flow path switching valve B4 acquires a driving electric power from a second driver D2. The second driver D2 receives a driving signal from the cleaning ECU 51 serving as the control unit E provided at the front portion of the vehicle 12. The cleaning ECU 51 transmits a driving signal to each of the second driver D2 and the first driver D1 based on the operation of the cleaning switch SW by the operator of the vehicle 12, for example.

The second flow path switching valve B4 is normally connected to a flow path for the rear window RW and is temporarily changed to be connected to a flow path for the rear camera CR when necessary. After the second flow path switching valve B4 changes its connection, the cleaning ECU 51 operates the water pump PW via a pump ECU 52 to discharge the fluid W from a cleaning nozzle NR of the rear camera CR. Because the second flow path switching valve B4 is operated on a basis of the operation of the cleaning switch SW by the operator, frequency of occurrence of operation noise of the second flow path switching valve B4 decreases, which leads to improved durability thereof.

As mentioned above, the second driver D2 and the second flow path switching valve B4 are provided at the rear flow path L2 to thereby increase a function of the cleaning apparatus U without changing the flow paths for the other cleaning objects such as the front window FW, for example, which are already provided and constructed at the vehicle 12.

In addition, because the second driver D2 which applies a driving current to the second flow path switching valve B4 is provided separately from the first driver D1, wiring for application of a relatively large electric current is arranged only at a region in the rear portion. Thus, wide or thick wiring including a large current carrying capacity is not necessarily arranged over a range from the front portion to the rear portion in the vehicle 12. Possibility of electric leakage from a connection in wiring, for example, is reduced, which leads to reduced cost of wiring for use.

The rear camera CR, for example, serving as the rear view support apparatus R is arranged at a position where air passing along an exterior surface of the vehicle 12 stops flowing, which may increase cleaning frequency. The fluid W sprayed on the rear camera CR is also difficult to be removed by air flowing along the exterior surface of the vehicle 12. Therefore, in the present embodiment, an air pump PA is provided to jet out cleaning air A to the rear camera CR when receiving a driving electric power from the second driver D2.

Timing at which the air pump PA is driven is determined by the cleaning ECU 51, the pump ECU 52 and the second driver D2. The application of driving electric power from the second driver D2 to the air pump PA conforms to timing at which the fluid W is discharged. For example, in a case where jetting of the cleaning air A is conducted consecutively after the end of discharge of the fluid W, the fluid W is removable, without insufficient dryness thereof, at a lens of the rear camera CR.

Because a driving electric power to the air pump PA is supplied from the second driver D2, wiring with a large diameter is not necessarily arranged over a range from the front portion of the vehicle 12 to the second driver D2, which leads to an easy mounting operation of the air pump PA.

Timing for cleaning the rear camera CR, for example, is determined by the operator who confirms an image of the rear camera CR and presses the cleaning switch SW. At this time, alternatively, a stain sensor S may be provided so as to automatically perform a cleaning operation. That is, the stain sensor S, which serves as an image recognition ECU, detects a stain of the rear view support apparatus R such as the rear camera CR, for example, to instruct the cleaning ECU 51 to send a driving signal to the second driver D2 and the water pump PW.

The stain sensor S determines how recognizable rear image information sent from the rear camera CR is. In a case where the stain sensor S evaluates a luminance difference between regions including obvious contrast differences in the rear image information and recognizes that a so-called edge portion is vague or blurred, the cleaning ECU 51 transmits a cleaning instruction to the second driver D2, for example.

According to the aforementioned construction, the rear camera CR is simply cleaned by changing the connection of the second flow path switching valve B4 only when the rear camera CR is stained. The second flow path switching valve B4 is normally specified in a way that the fluid W is supplied to the rear window RW of which clearing frequency is high. Thus, prompt cleaning of the rear window RW is achieved.

A sensor for detecting a stain may be also provided at the front camera CF arranged at the front portion of the vehicle 12, for example. Images acquired by the front camera CF, the right and left cameras CFR, CFL are processed at the stain sensor S. In a case where it is recognized that cleaning is necessary, a signal for starting the cleaning is transmitted to the cleaning ECU 51. Further, the cleaning ECU 51 transmits a driving signal to the first driver D1 and the pump ECU 52 to change the connection of each of the water pump PW and the first flow path switching valve B3. The first flow path switching valve B3 is normally specified to supply the fluid W to the front window FW. In a case where it is necessary to clean any one of the cameras, the first flow path switching valve B3 changes the connection so that the front flow path L1 is directed to the aforementioned camera.

A sectional area of a flow pipe constituting the rear flow path L2 may be specified greater than a sectional area of a flow pipe constituting the front flow path L1. Because a length of the rear flow path L2 is longer than a length of the front flow path L1, the flow pipe constituting the rear flow path L2 including a large diameter may decrease a flow resistance of the rear flow path L2 to thereby ensure discharge volume of the fluid W to the rear camera CR, for example.

The flow path switching valve according to the aforementioned embodiments is widely applicable to a valve which changes a flow path to which fluid flows by selecting a specified flow path among plural flow paths supplying the fluid.

According to the aforementioned embodiments, the flow path switching valve B includes the case C, C1, C2, the fluid supply portion 1 provided at the case C, C1 and supplying the fluid W to the inner void 3 of the case C, C1, the valve body V1 provided at the inner void 3 to be rotatable and including the first flow portion R1 through which the fluid W flowing from the fluid supply portion 1 flows to a specified flow destination, the valve body V1 including the first opposed surface F1 at which the first flow portion R1 opens, the second opposed surface F2 provided at the case C, C1 to face the first opposed surface F1, the biasing member P1 disposed over the case C, C1 and the valve body V1 to press the first opposed surface F1 of the valve body V1 against the second opposed surface F2, the drive portion K driving to rotate the valve body V1, the plural second flow portions R2 provided at the second opposed surface F2 to change a communication state relative to the first flow portion R1 based on a rotation phase of the valve body V1, and the plural fluid discharge portions 2 communicating with the plural second flow portions R2 respectively to discharge the fluid W to the specified flow destination, the fluid supply portion 1 being provided to open to a portion in the inner void 3, the portion being arranged opposite to the first opposed surface F1 relative to the valve body V1, the first flow portion R1 including the recess portion 4 which is provided at a region in a portion of the first opposed surface F1 to open towards the second opposed surface F2, the recess portion 4 being configured to face each of the plural second flow portions R2, the first flow portion R1 including the communication portion 5 which is provided at a region in a portion of the recess portion 4 as viewed in a direction orthogonal to the first opposed surface F1 to communicate between the recess portion 4 and the inner void 3.

According to the aforementioned construction, because the fluid supply portion 1 is provided to open to the portion in the inner void 3, the portion being arranged opposite to the first opposed surface F1 relative to the valve body V1, the valve body V1 is pressed in a direction of the first opposed surface F1 by the fluid W flowing to the inner void 3. That is, the first opposed surface F1 of the valve body V1 is pressed against the second opposed surface F2. The fluid W is therefore discharged only to the second flow portion R2 which is brought in communication with the first flow portion R1 based on the rotation phase of the valve body V1. Leakage of the fluid W to the other second flow portions R2 is inhibited. As a result, reliability of switching function switching between flow paths (flow portions) by utilizing the pressure of the fluid W may increase. While the construction is simplified, the flow path switching valve B with improved operation reliability is obtainable.

In addition, according to the aforementioned construction, while an area of the recess portion 4 which communicates with each of the second flow portions R2 is appropriately secured, a cross-sectional area of the communication portion 5 is reduced so that an area of a region in the valve body V1 positioned opposite to the first opposed surface F1 and facing the inner void 3 is secured to be enlarged.

Accordingly, the valve body V1 is strongly pressed against the second opposed surface F2 by the fluid W supplied to the inner void 3. As a result, one of the plural second flow portions R2 formed at the second opposed surface F2 is securely separated from the other second flow portions R2, thereby supplying the fluid W only to the specified flow destination.

According to the second embodiment, the flow path switching valve B further includes the second biasing member P2 disposed over the case C1 and the valve body V1 to bias the valve body V1 in a direction away from the second opposed surface F2, the second biasing member P2 bringing the first opposed surface F1 to a noncontact state relative to an object in a state where the fluid W is inhibited from being supplied to the inner void 3 from the fluid supply portion 1.

Because of the second biasing member P2, the valve body V1 is separated from the second opposed surface F2 in a state where the fluid W is inhibited from being supplied to the inner void 3 from the fluid supply portion 1. In this case, a driving resistance of the valve body V1 is reduced so that a prompt phase change of the valve body V1 is obtainable with a small force. As a result, the construction of the drive portion K is simplified and the entire flow path switching valve B is light-weighted, which may result in reasonable construction of the flow path switching valve B.

In addition, because the valve body V1 is separated from the second opposed surface F2, the fluid W which has been already supplied to the second flow portion R2 may be pulled back via the inner void 3. Thus, leaking of the fluid W to the flow destination after the supply of the fluid W is stopped is inhibited or freezing of the fluid W within a supply pipe (flow pipe) ahead of the second flow portion R2, for example, is avoidable.

According to the third embodiment, the flow path switching valve B further includes the seal member S1 configured to make contact with the first opposed surface F1 and the second opposed surface F2 to separate the plural second flow portions R2 from one another.

Because the second flow portions R2 are securely separated from one another by the seal member S1 configured to make contact with the first opposed surface F1 and the second opposed surface F2, the fluid W is inhibited from flowing to an unintended flow destination. The flow path switching valve B with improved operation reliability is therefore obtainable.

According to the third embodiment, the seal member S1 includes the positioning portion 20 in a cutting form engageable with the engagement projection 19 provided at an inner side of the case C1.

Accordingly, an outer peripheral portion of the seal member S1 engages with the engagement projection 19 provided at the inner side of the case C1 to thereby inhibit the seal member S1 from rotating with the rotation of the valve body V1.

According to the fourth embodiment, the valve body V1 includes the lateral surface Vd in a cylindrical form with a center of the rotation axis X of the drive portion K, the case C1 includes the inner wall Cd in a cylindrical form surrounding the lateral surface Vd of the valve body V1, the flow path switching valve B further including the second seal member S2 disposed between the lateral surface Vd of the valve body V1 and the inner wall Cd of the case C1.

Accordingly, the fluid W at the inner void 3 of the case C1 is securely inhibited from leaking to the second opposed surface F2 via a clearance between the valve body V1 and the inner wall of the case C1, for example. The valve body V1 is immediately pressed against the second opposed surface F2 by the fluid flowing to the inner void 3, thereby promptly and securely changing the flow path of the fluid W.

According to the fifth and sixth embodiments, the flow path switching valve B further includes the second valve body V2 provided at the first flow portion R1, the second valve body V2 being configured to open in a case where a pressure of the fluid W at the inner void 3 becomes equal to or greater than a predetermined pressure.

Accordingly, in a case where the fluid W flows to the inner void 3, a portion thereof at a side where the first opposed surface F1 is provided and a portion of the inner void 3 at a side opposite to the first opposed surface F1 relative to the valve body V1 are securely separated from each other. Thus, immediately after the fluid W is supplied to the inner void 3, the fluid W is inhibited from flowing to the portion where the first opposed surface F1 is provided, which leads to increase of a pressure at the inner void 3. As a result, the valve body V1 is pressed so that the first opposed surface F1 thereof is pressed against the second opposed surface F2, thereby separating the second flow portions R2 from one another.

Afterwards, the fluid W further flows to the inner void 3 to increase the pressure at the inner void 3. The second valve body V2 is opened so that the fluid W flows only to the specified second flow portion R2.

Accordingly, the fluid W is inhibited from being supplied to the second flow portion R2 which is not specified, so as to securely change the flow destination of the fluid W.

According to the seventh embodiment, each of the first opposed surface F1 and the second opposed surface F2 includes a spherical surface.

The fluid W flowing to the inner void 3 presses the valve body V1 towards the second opposed surface F2 while the position or posture of the valve body V1 is appropriately maintained. Nevertheless, in a case where a vibration is added to the flow path switching valve B, for example, the position or posture of the valve body V1 may be changed relative to the case C1. In this case, in a state where each of the first opposed surface F1 and the second opposed surface F2 is constituted by a flat surface, sealing performance of the first and second opposed surfaces F1 and F2 may be deteriorated.

Therefore, because each of the first opposed surface F1 and the second opposed surface F2 includes a spherical surface in the present construction, changes in clearance between the first opposed surface F1 and the second opposed surface F2 may be reduced to thereby secure the switching function switching between the flow destinations of the fluid W.

According to the aforementioned embodiments, the cleaning apparatus U includes the fluid tank T, the fluid pump P pumping and flowing the fluid W at the fluid tank T, flow paths through which the fluid W discharged from the fluid pump P flows, the flow paths including the second flow path L2 serving as the rear flow path which brings the fluid W to flow to a rear window 41 of a vehicle 12 and the first flow path L1 which brings the fluid W to flow to a cleaning object different from the rear window 41, the first flow path switching valve B3 provided at the first flow path L1 to specify at least one cleaning object as a supply destination of the fluid W, the first driver D1 supplying a driving electric power to the first flow path switching valve B3, the second flow path switching valve B4 provided at the second flow path L2 to change the supply destination of the fluid W to the rear view support apparatus R, the second driver D2 supplying a driving electric power to the second flow path switching valve B4, and the control unit E sending a driving signal to each of the first driver D1, the second driver D2 and the fluid pump P, at least one of the first flow path switching valve B3 and the second flow path switching valve B4 being constituted by the flow path switching valve B including the case C, C1, C2, the fluid supply portion 1 provided at the case C, C1 and supplying the fluid W to the inner void 3 of the case C, C1, the valve body V1 provided at the inner void 3 to be rotatable and including the first flow portion R1 through which the fluid W flowing from the fluid supply portion 1 flows to a specified flow destination, the valve body V1 including the first opposed surface F1 at which the first flow portion R1 opens, the second opposed surface F2 provided at the case C, C1 to face the first opposed surface F1, the biasing member P1 disposed over the case C, C1 and the valve body V1 to press the first opposed surface F1 of the valve body V1 against the second opposed surface F2, the drive portion K driving to rotate the valve body V1, the plural second flow portions R2 provided at the second opposed surface F2 to change a communication state relative to the first flow portion R1 based on a rotation phase of the valve body V1, and the plural fluid discharge portions 2 communicating with the plural second flow portions R2 respectively to discharge the fluid W to the specified flow destination, the fluid supply portion 1 being provided to open to a portion in the inner void 3, the portion being arranged opposite to the first opposed surface F1 relative to the valve body V1, the first flow portion R1 including the recess portion 4 which is provided at a region in a portion of the first opposed surface F1 to open towards the second opposed surface F2, the recess portion 4 being configured to face each of the plural second flow portions R2, the first flow portion R1 including the communication portion 5 which is provided at a region in a portion of the recess portion 4 as viewed in a direction orthogonal to the first opposed surface F1 to communicate between the recess portion 4 and the inner void 3.

Because of the second flow path switching valve B4 and the second driver D2 provided at the second flow path L2 serving as the rear flow path which brings the fluid W to flow to the rear window 41, a function of the cleaning apparatus may increase without a specific modification of a flow path related to the other cleaning object at a front portion of the vehicle 12 such as a front glass which is already provided and constructed at the vehicle 12.

In addition, because the second driver D2 related to the second flow path switching valve B4 is separately provided from the first driver D1, wiring for application of a relatively large electric current so as to drive the second flow path switching valve B4 is arranged only at a region in a rear portion of the vehicle 12. Thus, wide or thick wiring including a large current carrying capacity is not necessarily arranged over a range from the front portion to the rear portion in the vehicle 12. Possibility of electric leakage from a connection in wiring, for example, is reduced, which leads to reduced cost of wiring for use.

In addition, according to the aforementioned embodiments, the fluid pump P includes two discharge ports E1, E2 to which the second flow path L2 and the first flow path L1 are individually and respectively connected.

The supply destination of the fluid W is decided on a basis of an operation of the fluid pump P in a forward direction and a reverse direction so as to inhibit decrease in supply pressure of the fluid W especially to the rear window 41 and the rear view support apparatus R. That is, if the second flow path switching valve B4 is serially arranged at a downstream of the first flow path switching valve B3 related to the first flow path L1, the pressure of the fluid W discharged from the fluid pump P may be likely to decrease. Nevertheless, according to the present construction, the fluid W holding the original discharge pressure of the fluid pump P may be supplied to the first flow path switching valve B3 and the second flow path switching valve B4. Therefore, cleaning effect may be maintained to be high, in particular, at a rear camera, for example, serving as the rear view support apparatus R positioned away from the fluid pump P.

Further, according to the aforementioned embodiments, the flow path switching valve B further includes the air pump PA which receives a driving electric power from the second driver D2 to discharge the cleaning air A to the rear view support apparatus R.

The rear camera, for example, serving as the rear view support apparatus R is arranged at a position where air passing along an exterior surface of the vehicle 12 stops flowing, which may increase cleaning frequency. The fluid W sprayed on the rear camera is also difficult to be removed by air flowing along the exterior surface of the vehicle 12. Therefore, with the air pump PA as in the present construction, a rear view function may further increase. Because the driving electric power to the air pump PA is supplied from the second driver D2, wiring with a large diameter is not necessarily arranged over a range from the front portion of the vehicle 12 to the second driver D2, which leads to an easy mounting operation of the air pump PA.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A flow path switching valve comprising:
a case;
a fluid supply portion provided at the case and supplying a fluid to an inner void of the case;
a valve body provided at the inner void to be rotatable and including a first flow portion through which the fluid flowing from the fluid supply portion flows to a specified flow destination, the valve body including a first opposed surface at which the first flow portion opens;
a second opposed surface provided at the case to face the first opposed surface;
a biasing member disposed over the case and the valve body to press the first opposed surface of the valve body against the second opposed surface;
a drive portion driving to rotate the valve body;
a plurality of second flow portions provided at the second opposed surface to change a communication state relative to the first flow portion based on a rotation phase of the valve body; and
a plurality of fluid discharge portions communicating with the plurality of second flow portions respectively to discharge the fluid to the specified flow destination,
the fluid supply portion being provided to open to a portion in the inner void, the portion being arranged opposite to the first opposed surface relative to the valve body,
the first flow portion including a recess portion which is provided at a region in a portion of the first opposed surface to open towards the second opposed surface, the recess portion being configured to face each of the plurality of second flow portions, the first flow portion including a communication portion which is provided at a region in a portion of the recess portion as viewed in a direction orthogonal to the first opposed surface to communicate between the recess portion and the inner void.

2. The flow path switching valve according to claim 1, further comprising a second biasing member disposed over the case and the valve body to bias the valve body in a direction away from the second opposed surface, the second biasing member bringing the first opposed surface to a noncontact state relative to an object in a state where the fluid is inhibited from being supplied to the inner void from the fluid supply portion.

3. The flow path switching valve according to claim 1, further comprising a seal member configured to make contact with the first opposed surface and the second opposed surface to separate the plurality of second flow portions from one another.

4. The flow path switching valve according to claim 3, wherein the seal member includes a positioning portion in a cutting form engageable with an engagement projection provided at an inner side of the case.

5. The flow path switching valve according to claim 1, wherein
the valve body includes a lateral surface in a cylindrical form with a center of a rotation axis of the drive portion,
the case includes an inner wall in a cylindrical form surrounding the lateral surface of the valve body,
the flow path switching valve further comprising a second seal member disposed between the lateral surface of the valve body and the inner wall of the case.

6. The flow path switching valve according to claim 1, further comprising a second valve body provided at the first flow portion, the second valve body being configured to open in a case where a pressure of the fluid at the inner void becomes equal to or greater than a predetermined pressure.

7. The flow path switching valve according to claim 1, wherein each of the first opposed surface and the second opposed surface includes a spherical surface.

8. A cleaning apparatus comprising:
a fluid tank;
a fluid pump pumping and flowing a fluid at the fluid tank;
flow paths through which the fluid discharged from the fluid pump flows, the flow paths including a second flow path serving as a rear flow path which brings the fluid to flow to a rear window of a vehicle and a first flow path which brings the fluid to flow to a cleaning object different from the rear window;
a first flow path switching valve provided at the first flow path to specify at least one cleaning object as a supply destination of the fluid;
a first driver supplying a driving electric power to the first flow path switching valve;
a second flow path switching valve provided at the second flow path to change the supply destination of the fluid to a rear view support apparatus;
a second driver supplying a driving electric power to the second flow path switching valve; and
a control unit sending a driving signal to each of the first driver, the second driver and the fluid pump,
at least one of the first flow path switching valve and the second flow path switching valve being constituted by a flow path switching valve comprising:
a case;
a fluid supply portion provided at the case and supplying a fluid to an inner void of the case;
a valve body provided at the inner void to be rotatable and including a first flow portion through which the fluid flowing from the fluid supply portion flows to a specified flow destination, the valve body including a first opposed surface at which the first flow portion opens;
a second opposed surface provided at the case to face the first opposed surface;
a biasing member disposed over the case and the valve body to press the first opposed surface of the valve body against the second opposed surface;
a drive portion driving to rotate the valve body;
a plurality of second flow portions provided at the second opposed surface to change a communication state relative to the first flow portion based on a rotation phase of the valve body; and
a plurality of fluid discharge portions communicating with the plurality of second flow portions respectively to discharge the fluid to the specified flow destination,
the fluid supply portion being provided to open to a portion in the inner void, the portion being arranged opposite to the first opposed surface relative to the valve body,
the first flow portion including a recess portion which is provided at a region in a portion of the first opposed surface to open towards the second opposed surface, the recess portion being configured to face each of the plurality of second flow portions, the first flow portion including a communication portion which is provided at a region in a portion of the recess portion as viewed in a direction orthogonal to the first opposed surface to communicate between the recess portion and the inner void.

9. The cleaning apparatus according to claim 8, wherein the flow path switching valve includes a second biasing member disposed over the case and the valve body to bias the valve body in a direction away from the second opposed surface, the second biasing member bringing the first opposed surface to a noncontact state relative to an object in a state where the fluid is inhibited from being supplied to the inner void from the fluid supply portion.

10. The cleaning apparatus according to claim 8, wherein the flow path switching valve includes a seal member configured to make contact with the first opposed surface and the second opposed surface to separate the plurality of second flow portions from one another.

11. The cleaning apparatus according to claim 8, wherein the seal member includes a positioning portion in a cutting form engageable with an engagement projection provided at an inner side of the case.

12. The cleaning apparatus according to claim 8, wherein the valve body includes a lateral surface in a cylindrical form with a center of a rotation axis of the drive portion,
the case includes an inner wall in a cylindrical form surrounding the lateral surface of the valve body,
the flow path switching valve further comprising a second seal member disposed between the lateral surface of the valve body and the inner wall of the case.

13. The cleaning apparatus according to claim 8, wherein the flow path switching valve includes a second valve body provided at the first flow portion, the second valve body being configured to open in a case where a pressure of the fluid at the inner void becomes equal to or greater than a predetermined pressure.

14. The cleaning apparatus according to claim 8, wherein each of the first opposed surface and the second opposed surface includes a spherical surface.

15. The cleaning apparatus according to claim 8, wherein the fluid pump includes two discharge ports to which the second flow path and the first flow path are individually and respectively connected.

16. The cleaning apparatus according to claim 8, further comprising an air pump which receives a driving electric power from the second driver to discharge a cleaning air to the rear view support apparatus.
